(19) United States
(12) Patent Application Publication
(10) Pub. No.: US 2005/0283840 A1
(43) Pub. Date: Dec. 22, 2005

(54) Method for the automatic analysis of security requirements of information technology system

(76) Inventors: Daniel Le Metayer, Le Chesnay (FR); Claire Loiseaux, Versailles (FR); Christelle Lecomte, Versailles (FR)

Correspondence Address: WILLIAM ANTHONY DRUCKER, Suite 800, 1901 L Street, N.W., Washington, DC, 20036-3506, US

(21) Appl. No.: 10/872,233

(22) Filed: Jun. 18, 2004

(51) Int. Cl. H04L 9/00; H04L 9/32; G06F 11/30; G06F 12/14

(52) U.S. Cl. 726/27

(57) ABSTRACT

This invention concerns a method for the automatic analysis of security requirements in information technology systems. To this end, it proposes an automatic analysis process, implemented on a processor, and which allows: taking account of all security aspects, both organisational and technical, interacting with the users (security experts, decision makers, etc.) and synthesizing relevant information which can then be easily compared with the actual situation, systematically checking security information for completeness and consistency in order to detect potential weaknesses of the system (or future system). The method according to the invention enables the description and comparison of different structured views of the information. This information structuring principle meets requirements which are increasingly difficult to satisfy by human reasoning, because of the growing complexity of information technology systems and the vast increase in volumes of parameters and information to be considered.

### BACKGROUND OF THE INVENTION

1. Field of the Invention

The invention concerns a method for the automatic analysis of security requirements in information technology systems.

Its purpose is to analyse the security requirements of information technology systems so as to prevent omissions or conflicting requirements that might lead to major weaknesses in the system, and to provide justifications for the countermeasures required to ensure the security of the system.

2. Description of the Prior Art

The security of information technology systems is becoming both more and more complex and increasingly crucial for modern companies. The management of risks, which was initially the exclusive expertise of the military area and certain specific industrial sectors, has long been a very confidential topic with secret and company specific practices. Current risk management processes are based on:
either empirical approaches, which are by essence subjective and difficult to justify or
objective or formal (mathematically grounded) methods, which are rigorous but difficult to apply to concrete situations and rather inflexible. In addition such methods require a strong expertise in the mathematical theories involved, which is a strong limitation for a wider use.

In both cases, there is a lack of automatic tools which would allow the security analysis task to be automated.

### OBJECT OF THE INVENTION

This invention therefore has the particular aim of filling the gap between pragmatic but non systematic methods on one hand and methods which are more rigorous but also more difficult to apply on the other hand.

### SUMMARY OF THE INVENTION

To this end, it proposes an automatic analysis method, implemented on a processor, and which allows:

taking account of all security aspects, both organisational and technical,

interacting with the users (security experts, decision makers, etc.) and synthesizing relevant information which can then be easily compared with the actual situation,

systematically checking security information for completeness and consistency in order to detect potential weaknesses of the system (or future system).

The method according to the invention enables the description and comparison of different structured views of the information. This information structuring principle meets requirements which are increasingly difficult to satisfy by human reasoning, because of the growing complexity of information technology systems and the vast increase in volumes of parameters and information to be considered.

The process according to the invention involves:

Actors (including, for example, human beings, companies, organisations, applications, etc.) capable of performing certain actions (whether authorised or malicious) on the system. For reasons of convenience, these actors can be grouped into classes (or roles), which makes it possible to treat them in a uniform manner. With each actor (or class of actors), it is possible to associate attributes such as a, for example, its confidence level, or its means (characterising its ability to carry out certain attacks). Such attributes can be numerical values or values of a more complex nature allowing the information to be described more precisely. As far as means are concerned, for example, it is possible to distinguish the hardware means (oscilloscope, etc.), the qualifications (knowledge of specific techniques, etc.), the determination, and the potential benefits that the actor could gain from a malicious action.

Assets, which are the valuable items to be protected, such as, for example, data in memory, hardware (processor, hard disk, diskette, cable, etc.), applications in memory, electromagnetic radiations, etc. Included in this list are items such as electromagnetic radiations, whose value is indirect in the sense that it supplies information on other assets (what is usually referred to as “information flow”). For reasons of convenience, assets can be grouped into classes, which make it possible to treat them in a uniform way. With each asset (or class of assets), it is possible to associate attributes such as its required protection types (integrity or authenticity for example) or its sensitivity levels characterising its degree of sensitivity in a predefined scale. Such sensitivity levels can be numerical values or information of a more complex nature distinguishing, for example, between the types of possible attacks or the types of actors capable of performing these attacks.

Locations, such as, for example, geographical zones (whether secure or not), memory pages (volatile or not), electric cables used as a communication media, etc. In general, a location corresponds to an asset container. The distinction between assets and locations makes it possible to deal with both “access control” and “control flow” security policies. However the method according to the invention does not prevent some locations themselves to be also considered as assets. For reasons of convenience, the locations can be grouped into classes, so that they can be treated in a uniform manner. With each location (or class of locations), it is possible to associate attributes such as, for example, a physical type (hard disk, diskette, ROM, RAM, EEPROM, cable, electromagnetic emission, etc.) or a level of protection (provided by the location) against certain types of attacks. Such protection levels can be numerical values or information of a more complex nature enabling the protection to be described in a more precise manner.

### DESCRIPTION OF THE PREFERRED EMBODIMENTS

The method according to the invention concerns the automatic analysis of the security requirements of information technology systems. It involves the construction and the analysis of a security model associating:

with each actor (or class of actors) a set of access rights and interdictions to certain locations (or classes of locations),

with each actor (or class of actors), a set of access rights and interdictions to certain assets (or classes of assets),

with each asset (or class of assets), a set of locations (or classes of locations) which can contain the said asset (or class of assets).

These associations can be defined by means of tables constructed systematically through interactions with one or several users, and then analysed in an automatic way.

The construction and analysis of the above security model enables to:

derive the threats in an automatic manner, and thus provide a way for designers to rely on objective and rational grounds to make the design and development choices,

provide users with means to manipulate the security information and to measure the impact of each decision on the security model, thereby detecting, for example, whether an access right granted to a particular actor for functional purposes conflicts with the presence of a confidential asset in a given location, potentially leading to a security weakness,

communicate with and convince a broader community (beyond the circle of security experts) regarding the security choices and consequences thereof,

make explicit the security assumptions and the choices which have led to the design of an information technology system.

Embodiments of the invention can thus be used to support the growing need for transparency and better understanding of security issues which is currently manifesting itself in various ways such as the use of public and standard encryption algorithms (as opposed to company specific, secret algorithms), the publication of protection profiles in accordance with standards such as the Common Criteria—The “Common Criteria for Information Technology Security Evaluation” is a widely used international standard (ISO/IEC 15408) for security evaluations. Although the process according to the invention can be used in the context of the Common Criteria, it is not restricted to it in any way, the obligation to make public the security target in order to receive the mutual recognition of Common Criteria certificates, etc.

The six types of relations describing a basic security model according to the invention can be implemented as tables (which is a preferred embodiment but not a limitation of the invention) as follows:

the table of access rights to locations, associating with each actor (or class of actors) a set of access rights to certain locations (or classes of locations),

the table of access interdictions to locations, associating with each actor (or class of actors) a set of access interdictions to certain locations (or classes of locations),

the table of access rights to assets, associating with each actor (or class of actors) a set of access rights to certain assets (or classes of assets),

the table of access interdictions to assets, associating with each actor (or class of actors) a set of access interdictions to certain assets (or classes of assets),

the location table associating with each asset (or class of assets) a set of locations (or classes of locations) which can contain this asset,

the inclusion table associating with certain actors (or classes of actors) the classes of actors which include them, with certain assets (or classes of assets) the classes of assets which include them and with certain locations (or classes of locations) the classes of locations which include them.

A simple version of these tables can contain Boolean information (access authorised or forbidden, location possible or not). It may nevertheless be preferable in some cases to introduce more precise information into these tables so as to be able to describe the actual situations in a more detailed manner.

The process according to the invention proposes the following refinements:

each of the aforementioned tables can store information on the contexts in which the access rights are granted or forbidden, and in which the locations are possible or not, where the said contexts can, for example, involve information about the internal state of the system, the stages in its life cycle, or the values of certain data or parameters, etc.;

the first four tables can store information on the types of access, distinguishing, for example, read access, write access, execution access, use access, etc.;

the location table can store information on the form of the asset in a given location, distinguishing, for example, un-ciphered data, data ciphered using a given algorithm and key length, data split into several parts in order to make its extraction more difficult, data associated with information used to verify its integrity (checksum for example).

In the same way, and still with a view to a more detailed analysis of the security requirements and the countermeasures needed to address certain types of threats, the method according to the invention can be used to characterise the assets (and classes of assets) and the actors (and classes of actors) in the following way:

the assets (and classes of assets) can be associated with attributes such as, for example, a required protection type (integrity, authenticity, etc.) or levels of sensitivity, where the said sensitivity levels can be numerical values or information of a more complex nature allowing to describe the sensitivity more precisely, identifying, for example, the types of attacks possible upon the asset or the types of actors capable of conducting these attacks;

the actors (and classes of actors) can be associated with attributes such as, for example, a level of confidence, or a set of means characterising their ability to conduct certain attacks; said means can be numerical values or information of a more complex nature used to describe the information more precisely, including for example, the hardware means (oscilloscope, etc.), qualifications (knowledge of specific techniques, etc.), determination, and the potential benefits that an actor may gain through a malicious action.

The model according to the invention can also include the following relations, such relations can also be implemented as tables (which is a preferred embodiment but not a limitation of the invention), which can be used to refine the security analysis:

a dependency table, which stores the dependencies, or information flows, between the assets (or classes of assets); this table enables to store the fact that the knowledge of an asset (or a class of assets) indirectly provides information on another asset (or class of assets);

a collusion table, which stores the relations, known as collusion relations, between the actors (or classes of actors), which can group together their means and their information in order to perpetrate attacks; this table can be used, for example, to store the fact that knowledge of an item of information by an actor (or class of actors) can lead to the same knowledge by another actor (or another class of actors);

a transition table which stores the possible transitions between the contexts and the actors (or classes of actors) capable of triggering such transitions; from the knowledge of an initial context, this table can be used to determine all of the attainable contexts and the actors (or classes of actors) capable of triggering context changes.

The process according to the invention allows cross checks to be performed between the different sources of information represented in the model, so as to detect any potential security weakness of the system. Such weaknesses can manifest themselves in two ways during the security analysis:

inconsistency, which indicates the supply (or derivation by logical reasoning) of contradictory information.

incompleteness, which indicates the omission of certain information;

The process according to the invention proposes the following consistency verifications:

verification on the table of access rights to locations and the table of access interdictions to locations in order to detect any contradiction that could reveal the existence of potential threats, where these contradictions can be expressed, for example, by the fact that an actor (or class of actors) can be, in a given context, associated with both the right and the interdiction of a certain type of access;

verification on the table of access rights to assets and the table of access interdictions to assets in order to detect any contradictions that could reveal the existence of potential threats, where these contradictions can be expressed, for example, by the fact that an actor (or class of actors) can be, in a given context, associated with both the right and the interdiction of a certain type of access;

verification on the table of access rights to locations, the table of access interdictions to locations, and the location table, in order to detect any contradictions that could reveal the existence of potential threats, where these contradictions can be expressed, for example, by the fact that an actor (or class of actors) can be, in a given context, associated with the interdiction of a certain type of access to an asset (or class of assets) when it can obtain this access indirectly through an access to a location (or class of locations) which may contain this asset (or class of assets);

verification on the table of access rights to assets, the table of access interdictions to assets and the dependency table, in order to detect any contradictions that could reveal the existence of potential threats, where these contradictions can be expressed, for example, by the fact that an actor (or class of actors) can be, in a given context, associated with the interdiction of a certain type of access to an asset (or class of assets) when it can obtain this access indirectly through an access to an asset (or class of assets) providing information on the former (such that there exists a flow of information between the two assets).

verification on the table of access rights to locations, the tables of access rights and interdictions to assets, the location table, and the transition table, in order to detect any contradictions that could reveal the existence of potential threats, where these contradictions can be expressed, for example, by the fact that an actor (or class of actors) can be, in a context C, associated with the interdiction of a certain type of access to an asset (or class of assets) when it can obtain this access indirectly through a transition used to reach another context C′ in which the actor (or class of actors) has the right to access this asset (or class of assets) or can get access to a location (or class of locations) which may contain this asset (or class of assets);

verification on the table of access rights to assets, the table of access interdictions to assets, and the collusion table, in order to detect any contradictions that could reveal the existence of potential threats, where these contradictions can be expressed, for example, by the fact that an actor (or class of actors) A can be, in a given context, associated with the interdiction of a certain type of access, the actor (or classes of actors) A′ is associated (in the same context) with the access right, and the collusion table indicates that the actors (or classes of actors) A and A′ are able to exchange information;

verification on the table of access rights to locations, the table of access interdictions to locations and the collusion table, in order to detect any contradictions that could reveal the existence of potential threats, where these contradictions can be expressed, for example, by the fact that an actor (or class of actors) A can be, in a given context, associated with the interdiction of a certain type of access, whereas the actor (or classes of actors) A′ is associated with this access right, and the table of collusions indicates that the actors (or class of actors) A and A′ are able to exchange information;

verification on the inclusion tables and one or more of the other tables, in order to detect any contradictions expressed by the fact that an actor (or class of actors) A is included in a class of actors C and that A and C possess contradictory access rights and/or interdictions;

verification on the inclusion table and one or more of the other tables, in order to detect any contradictions expressed by the fact that an asset (or a class of assets) A is included in a class of asset C and that A and C are associated with contradictory access rights and/or interdictions;

verification on the inclusion table and one or more of the other tables, in order to detect any contradictions expressed by the fact that a location (or class of locations) L is included in a class of location (C) and that L and C are associated with contradictory access rights and/or interdictions.

In an embodiment of the invention, the security model can be constructed through of a series of interactions with one or several users (such as security experts, issuer, designer, etc.). The embodiment of the invention can include output facilities to display questions to the users, the answers to such questions being used to fill in the tables defining the model.

The detection of an inconsistency in the model can trigger one of the following processes:

display of a message to the user with a description of the inconsistency accompanied by a question to the user who must then resolve the detected inconsistency by modifying one (or several) of the tables making up the model;

display of a message to the user with a description of the inconsistency accompanied by one or several suggestions for strengthening the model and solving the inconsistency. An example of such strengthening could be, for example, the deletion or limitation of an access right to a location (or class of locations) or to an asset (or class of assets), and the user can then select one of the proposed suggestions.

The completeness of the information contained in the model can be ensured in one of the following ways:

the tables defining the security model are filled in through interactions with the user, who has to supply the necessary information until the model is complete;

the tables defining the security model are completed automatically in accordance with a “caution assumption” (or maximum security assumption), expressed, for example, by the fact that an access which is not explicitly granted in a given context is automatically considered as forbidden.

1. A method for the automatic analysis of security requirements of information technology systems, involving:
actors which are capable of performing certain actions on the system;
assets which represent the items to be protected;
locations which can contain assets;
classes (or sets) of said actors, assets or locations;
comprising at least the construction and analysis of a security model including the following associations:
association with each actor (or class of actors) of a set of access rights to certain locations (or classes of locations);
association with each actor (or class of actors) of a set of access interdictions to certain locations (or classes of locations);
association with each actor (or class of actors) of a set of access rights to certain assets (or classes of assets);
association with each actor (or class of actors) of a set of access interdictions to certain locations (or classes of locations);
association with each asset (or class of assets) of a set of locations (or classes of locations) which can contain it;
association with certain actors (or classes of actors) of the classes of actors which can include them;
association with certain assets (or classes of assets) of the classes of asset which can include them;
association with certain locations (or classes of locations) of the classes of locations which can include them;
said model is constructed through interactions with one or several users, and then analysed in an automatic way.

2. A method according to claim 1, comprising at least:
the association with each actor (or class of actors) of a set of access rights to certain locations (or classes of locations) by means of a table of access rights to locations;
the association with each actor (or class of actors) of a set of access interdictions to certain locations (or classes of locations) by means of a table of access interdictions to locations;
the association with each actor (or class of actors) of a set of access rights to certain assets (or classes of assets) by means of a table of access rights to assets;
the association with each actor (or class of actors) of a set of access interdictions to certain assets (or classes of assets) by means of a table of access interdictions to assets;
the association with each asset (or class of assets) of a set of locations (or classes of locations) which can contain it, by means of a location table;
the association with certain actors (or classes of actors) of the classes of actors which can include them, with certain assets (or classes of assets) of the classes of assets which can include them, and with certain locations (or classes of locations) of the classes of locations which can include them, by means of an inclusion table.

3. A method according to claim 2, wherein the access rights to locations, the access interdictions to locations, the access rights to assets and the access interdictions to assets, store information on the contexts in which the access rights are granted or forbidden, said contexts possibly involving, at least, information about the internal state of the computer, or the life cycle of the computer, or the values of certain data or parameters.

4. A method according to claim 2, wherein the location table stores information on the contexts in which a location (or a class of locations) can contain an asset (or a class of assets), said contexts possibly involving, at least, information about the internal state of the computer, or the life cycle of the computer, or the values of certain data or parameters.

5. A method according to claim 2, wherein the tables of access rights to locations and access interdictions to locations, access rights to assets and access interdictions to assets, store information on the types of possible accesses, such types possibly including, at least, read accesses, write accesses, execution accesses or use accesses.

6. A method according to claim 2, wherein t the location table stores information on the form of the assets (or classes of assets) in the given locations (or class of locations), said form is defined by a meaningful attribute.

7. A method according to claim 6, wherein t the said attribute consists, at least, of an information indicating, as appropriate depending on the form of the asset, the fact that the asset is encrypted or not, or the encryption algorithm and key length used to encrypt the asset, or the fact that the asset is split into several parts, or an information item which can be used to verify the integrity of the asset.

8. A method according to claim 1, wherein the model includes information on the types of assets (or classes of assets), where an asset (or a class of assets) can be, at least, of the physical or logical type.

9. A method according to claim 1, wherein the assets (or classes of assets) are associated with information characterising their degree of sensitivity in a predefined scale, said information being a numerical value or information of a more complex nature allowing the sensitivity to be described in greater detail, possibly identifying, at least, the types of possible attacks on the asset (or class of assets) or the types of actors capable of conducting these attacks.

10. A method according to claim 1, wherein the actors (or classes of actors) are associated with information characterising their means or ability to conduct certain types of attacks, said information being a numerical value or information of a more complex nature allowing the means of the actors to be described in greater detail, possibly identifying, at least, the hardware means, the qualifications of the actor, the level of determination of the actor or the potential benefits that the actor can gain from the attack.

11. A method according to claim 1, comprising at least:
a dependency table which stores dependencies or information flows between assets (or classes of assets);
a collusion table which stores relations, called collusion relations, between the actors (or classes of actors) which can group together their resources and their information in order to perpetrate attacks;
a transition table which stores the possible transitions between the contexts and the actors capable of triggering such transitions;

12. A method according to claim 2, comprising an analysis of the aforementioned tables to detect contradictions, said contradictions revealing the existence of potential threats against the security of the system.

13. A method according to claim 12, characterised in that it comprising the processing of an inconsistency detected through a verification on the model in accordance with one of the following methods:
an indication to the user, who must then resolve said detected inconsistency by modifying one or several items of information defining the model;
an indication to the user, accompanied by suggestions for strengthening of the model, allowing said detected inconsistency to be resolved.

14. A method according to claim 2, comprising an automatic completion of the information contained in the model, achieved in accordance with one of the following methods:
the tables which define the security model are filled in by means of interactions with the user, who has to supply the necessary information until the model is complete;
the tables which define the security model are completed automatically in accordance with a caution assumption, expressed by the fact that an access that is not explicitly granted in a given context is automatically forbidden.

15. A method according to claim 1, wherein it is applied to the definition of security requirements or security targets, as required for an evaluation in the context of official standards, such as the Common Criteria at least.
